(19) United States
(12) Patent Application Publication
(10) Pub. No.: US 2007/0121152 A1
(43) Pub. Date: May 31, 2007

(54) Variable Digital Publishing

(76) Inventors: Brian T. CupChoy, San Diego, CA (US); Michael S. Finnigan, Issaquah, WA (US); Konstantin Kovtoun, San Diego, CA (US); Jason K. Kapono, Vista, CA (US); Calin M. Bauer, Richmond Hill (CA)

Correspondence Address: MERCHANT & GOULD PC, P.O. BOX 2903, MINNEAPOLIS, MN, 55402-0903, US

(21) Appl. No.: 11/557,415

(22) Filed: Nov. 7, 2006

Related U.S. Application Data
(60) Provisional application No. 60/741,364, filed on Nov. 30, 2005.

(51) Int. Cl. G06F 3/12

(52) U.S. Cl. 358/1.15; 358/1.13

(57) ABSTRACT

A variable digital publishing application and system is described for generating communications tailored to individual recipients. The digital publishing application allows a user to control, submit and monitor the processing of a job to generate a batch of communications. The job is submitted to a variable information application, which populates templates with variable information to create digital files. The digital files are sent to a data delivery system, which generates the communications using the digital files and delivers the communications to the recipients. Status information is sent throughout the processing of a job to allow a user to monitor the job using the digital publishing application.

### CROSS-REFERENCE TO RELATED APPLICATIONS

This application claims priority to U.S. Provisional Patent Application No. 60/741,364 filed on Nov. 30, 2005, which is hereby incorporated by reference in its entirety as if set forth herein in full.

### BACKGROUND OF THE INVENTION

Variable data publishing enables direct, targeted marketing/communication to individual consumers/recipients. Variable data publishing takes information about individuals, e.g., address, phone, demographic information, survey information, web browsing information etc. and uses the information to generate communications with variable information tailored to each individual recipient. The communications may be customized in their text and graphics to appeal to the intended recipients. This makes the communications more powerful than if they were generic.

Currently, variable data publishing systems use variable information applications for creating templates with locations within the template where variable information is placed. As stated above, the variable information may be text or graphical information and is specifically selected based on the recipient information, e.g., preferences. As one simple example, common business correspondence may be generated using a variable information application. A standard letter, for example communicating a change in address, may be generated as a template with locations for inserting individual addresses and names of the intended recipients. The variable information application will then use the template to generate individual customized letters with the specific variable information of the recipients.

It is often desirable to market/communicate with individuals using different mediums of communication. For example, it may be effective to market some subset of consumers using print materials and yet others might be more effectively targeted using electronic mail (e-mail). In yet other situations it may be more effective to use multiple mediums of communication to target a single consumer. However, generating variable information communications in different formats typically requires the establishment of separate systems for each format. Each system must then be separately operated, maintained and serviced which is costly and inefficient.

It is with respect to these and other considerations that the present invention has been made. Also, although relatively specific problems have been discussed, it should be understood that embodiments of the present invention should not be limited to solving these problems, and in fact may address other issues.

### SUMMARY OF THE INVENTION

In one aspect, the present invention relates to a variable digital publishing system that is capable of generating communications with variable information. The system may include the use of computer systems, applications such as variable information software applications and digital asset management applications and databases. The system includes an application that allows a user to submit jobs for processing to generate communications, and monitor and track the processing of the jobs. The communications may be in a variety of forms, including printed communication, web site communications and e-mail communications.

In another aspect, the present invention relates to methods of facilitating the interface of a variable information application with a digital asset management application. In one embodiment of this aspect, an asset object is instantiated to handle requests by a variable information application for digital assets managed by the digital asset management application. The asset object accesses information associated with the requested asset from the digital asset management application through an API of the digital asset management application. The object then returns the information associated with the digital asset to the variable information application.

The summary is provided for explanatory purposes only. The appended claims define the invention, and this summary is not intended to limit the scope of the appended claims.

### BRIEF DESCRIPTION OF THE FIGURES

FIG. 1 illustrates a block diagram of a suitable computing and operating environment in which aspects of the present invention may be implemented.

FIG. 2 illustrates a block diagram illustrating a variable digital publishing system according to one embodiment of the present invention.

FIG. 3 illustrates a block diagram illustrating a variable digital publishing system according to a second embodiment of the present invention.

FIG. 4 illustrates a block diagram of an application for controlling, accessing and managing a variable digital publishing system according to an embodiment of the present invention.

FIG. 5 illustrates a flow chart for a process of generating variable information communications according to an embodiment of the present invention.

FIG. 6 illustrates a flow chart for a process of retrieving information associated with a digital asset managed by a digital asset management application for use in variable information templates according to an embodiment of the present invention.

FIG. 7 illustrates a flow chart for a process of retrieving the storage location of a digital asset, managed by a digital asset management application, for use in generating a digital output file according to an embodiment of the present invention.

### DETAILED DESCRIPTION OF THE INVENTION

The present invention relates to variable digital publishing systems and methods for use in generating communications individually tailored for a recipient. The communications may be in a variety of forms, e.g., print, e-mail, website displays. The variable digital publishing systems may include computer systems, databases, and software applications. The following is a description of components, applications, modules, steps, processes and systems of some embodiments of the present invention. The scope of the present invention is not intended to be limited by the following description.

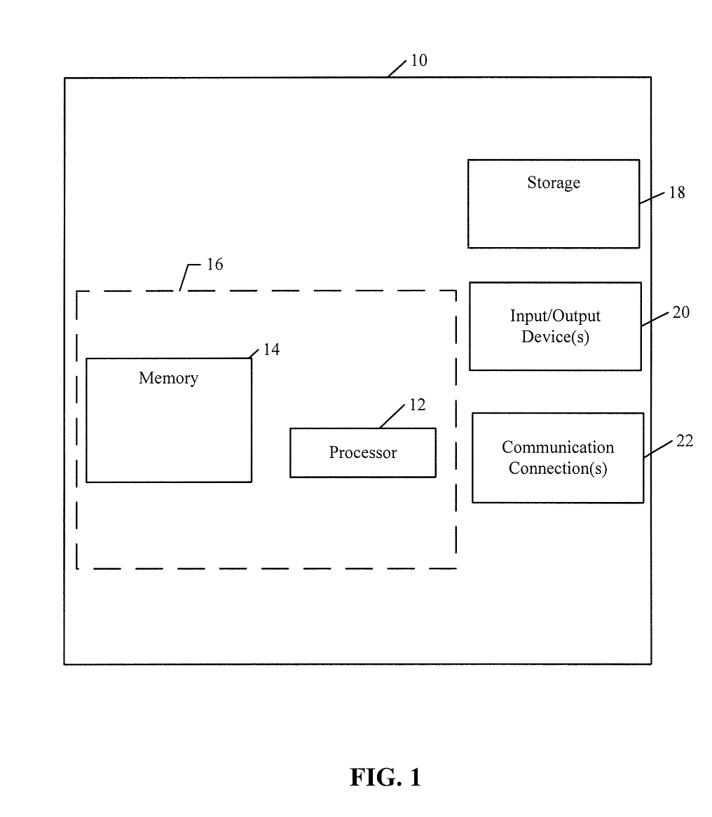

FIG. 1 is a block diagram illustrating a computing environment for implementing embodiments of the present invention that includes a computing system 100. In one configuration, computing system 10 includes a processor 12 and memory 14. Memory 14 may be volatile (such as RAM), non-volatile (such as ROM, flash memory, etc.), or a combination of volatile and non-volatile memory. Dashed line 16 illustrates a basic configuration of the computing device 10 including only processor 12 and memory 14. System 10 may have additional functionality than that provided by processor 12 and memory 14. As shown in FIG. 1, system 10 may also have storage 18. Storage 18 may include volatile and nonvolatile, removable and non-removable storage media. Storage 18 may be implemented using any suitable method or technology for storing information and data such as program modules, data structures, or computer readable instructions. Memory 14 and storage 18 are all examples of computer readable media. Computer readable media includes, but is not limited to, RAM, ROM, EEPROM, flash memory or other memory technology, CD-ROM, digital versatile disks (DVD) or other optical storage, magnetic cassettes, magnetic tape, magnetic disk storage, other magnetic storage devices, or any other medium which can be used to store information, and which can be accessed by system 10 and processor 12. Any such computer storage media may be part of system 10.

System 10 may also include input/output device(s) 20 such as keyboard, mouse, pen, voice input device, touch input device, a display, speakers, printer, etc. These devices, either individually or in combination can form a user interface.

System 10 may include communications connection(s) 22 for communicating with other devices or computer systems. Communications connection(s) 22 is an example of communication media. Communication media includes wired media such as a wired network or direct-wired connection, and wireless media such as acoustic, RF, infrared, and other wireless media.

The operating environment is only one example of a suitable operating environment and is not intended to suggest any limitation as to the scope of use or functionality of the invention. Other well known computing systems, environments, and/or configurations that may be suitable for use with the invention include, but are not limited to, personal computers, server computers, hand-held or laptop devices, multiprocessor systems, microprocessor-based systems, programmable consumer electronics, network PCs, minicomputers, mainframe computers, distributed computing environments that include any of the above systems or devices, and the like.

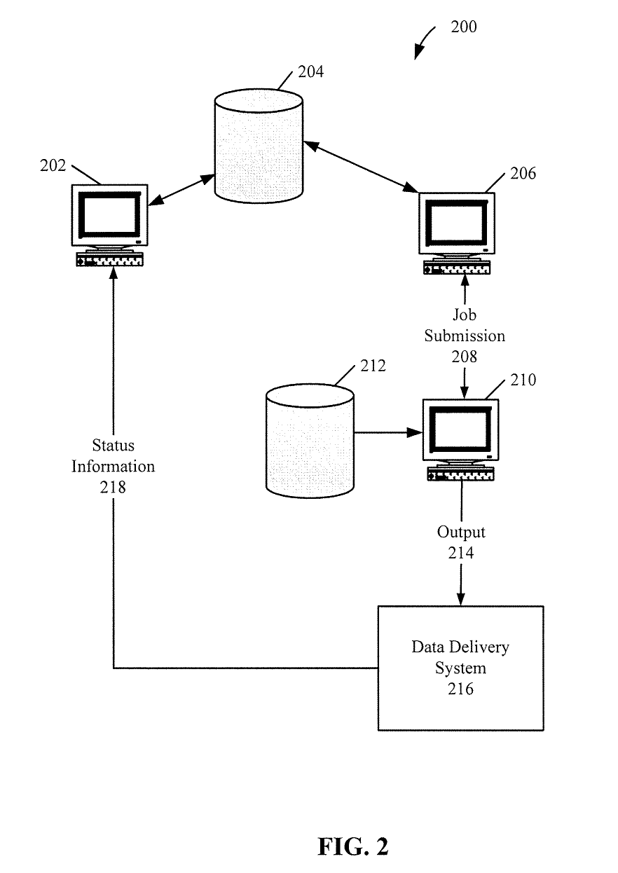

FIG. 2 is a block diagram illustrating a basic variable digital publishing system 200 according to one embodiment of the present invention. The system 200 includes computer systems 202, 206 and 210. Computer systems 202, 206 and 210 represent any suitable computing system such as computing system 100 described above with respect to FIG. 1. Additionally, the variable digital publishing system 200 includes databases 204 and 212, which may be implemented using any computer storage media. Additionally, system 200 includes data delivery system 216, which as described in more detail below, receives a digital output 214 generated by computer system 210, creates communications using the digital output, and delivers the communications to recipients.

System 200 also includes a digital publishing application that facilitates the establishment of a single digital publishing system for generating communications in a variety of forms, which eliminates the need to have separate systems for print communication, e-mail communications and website communications as is typically the case for conventional publishing systems. The digital publishing application also allows a user to control and track the generation of communications from initiating a job (a batch of communications) for processing, through delivery of the communication to the intended recipients. As is described in greater detail below, the digital publishing application includes a number of modules/components, including but not necessarily limited to a job management module, a job submission module, and a project management module. In some embodiments, the modules may be installed and run on different computer systems (i.e., a distributed computing environment), and in other embodiments the modules may all be installed on a single computer system.

With reference to FIG. 2, system 200 generally operates as follows. Computer system 202 runs a number of software applications. One software application is a variable information application that allows a user to create templates with fields to be populated with variable information (e.g., customer profile information, text data and image data). The templates are used in creating multiple varied communications incorporating variable information into the template fields. Any suitable variable information application may be used with the present application, one suitable example being Pageflex Studio.

In addition to the variable information application, computer system 202 also runs a job management module of the digital publishing application. The job management module includes a graphical user interface. The job management module advantageously allows a user to perform a variety of functions in system 200, such as queue jobs (a batch of communications) for processing by system 200 to generate communications, monitor/track the processing of a job by system 200, and monitor/track the delivery of communications to intended recipients.

Using the job management module, a user inputs job parameters, i.e., information used by system 200 to process a job. The job parameters include a selected form for the communications (e.g., e-mail, print, etc.), information indicating the templates to be used in generating the communications and information indicating the variable information to be used to populate the templates.

A user utilizes the job management module to queue a job for processing by system 200. By “queue” it is meant that a user has initiated a job for processing by system 200. When a job is queued for processing, the job parameters input by a user are submitted to a queue, i.e., a storage location within database 204. Computer system 206 runs a job submission module of the digital publishing application. The job submission module monitors the queue in database 204 for jobs that have been queued. By “monitors” it is meant that it periodically checks the queue to determine whether a job has been queued by a user. When a job has been queued, the job submission module examines the job parameter information associated with the queued job. As stated above, the job parameters indicate the templates to be used in generating the communications and the variable information to be used in generating the communications. Job submission module uses the job parameter information to retrieve the template files and variable information from their storage location, which in system 200 is within database 204. The job submission module creates a job submission 208 with the necessary information (template files, variable information, and job parameters, such as the final form of the communications) for processing the job. The job submission 208 is sent to computer system 210 for processing. Additionally, job submission module communicates information to the job management module to allow the job management module to track the status of a job, i.e., whether a queued job has been submitted to computer system 210 for processing. As shown in FIG. 2, job submission module will store status information in database 204, where it can be accessed by the job management module.

Computer system 210 runs variable information software that processes the job submission 208 to create output 214. The variable information software application populates the templates included in job submission 208 with the variable information also included in job submission 208 to generate digital output 214. Any suitable variable information application may be used with the present invention, one example being M-Power Server. In some embodiments, the templates in job submission 208 may reference image data stored in database 212. In these instances, the variable information application will access database 212 to retrieve image data for populating the templates with the image data.

The job management module also receives information from the variable information application to allow a user to monitor the generation of the output 214. In some embodiments, the information may be communicated directly, while in other embodiments, as shown in FIG. 2, the job submission module on computer system 208 communicates information from the variable information application to database 204, where it is accessed by the job management module.

The digital output 214 generated by the variable information application includes a number of digital files each having variable information tailored for a specific recipient. The digital files of output 214 are used to generate the final communications. In some embodiments, the digital files of output 214 are an intermediate form of the final communications. In these embodiments, the digital files are further processed to generate the final communications. The further processing of the digital files may involve a number of steps, depending on the form of the final communications. The steps may include, without limitation, renaming the files, printing the files and converting the files to a different file format. In other embodiments, the digital files may be in the final form for the communications. In these embodiments, the final communications are generated by merely sending or delivering the digital files to the intended recipients.

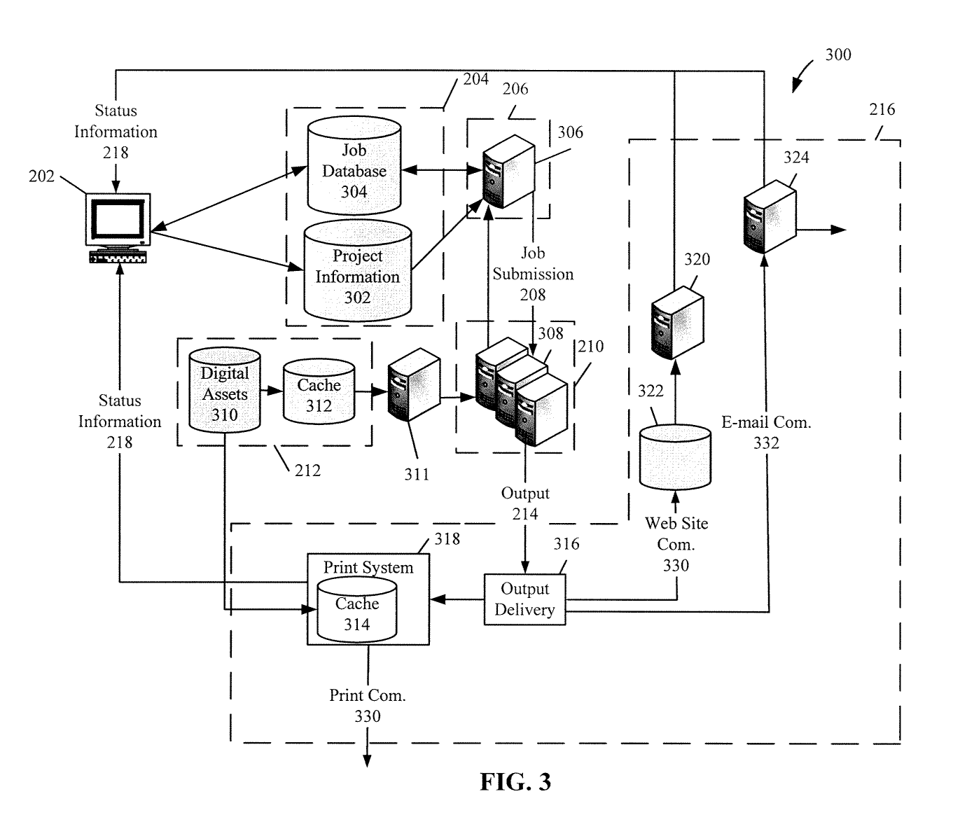

After being generated by the variable information application on computer system 210, output 214 is sent to a data delivery system 216 for further processing, if necessary. Additionally, system 216 generates the final communications and delivers the communications to the intended recipients. An exemplary data delivery system is described below with respect to FIG. 3 and system 300.

Data delivery system 216 provides status information 218 to the job management application on computer system 202. The status information indicates whether the communications have been successfully generated and delivered to the recipients. Status information 218 is stored in database 204, and may be accessed by a user using the job management module.

As described above, the digital publishing application (i.e., job management module and job submission module) provides a user the ability to control the generation and delivery of communications (which may be in a variety of forms) using a single integrated digital publishing system. The digital publishing application also allows a user to monitor the generation of communications from initiating the processing of a job, through the various steps of processing, and finally delivery of the communications to the intended recipients.

The description above is intended to be general and merely an overview of a basic embodiment of a variable digital publishing system and a digital publishing application according to the present invention. In this regard, system 300 described below with respect to FIG. 3, illustrates an embodiment of a variable digital publishing system 300, and description of a digital publishing application, with additional systems, components, modules and/or applications.

System 300 includes similar parts as system 200, which are numbered the same in FIG. 2 and FIG. 3 (computer systems 202, 206 and 210, databases 204 and 212 and data delivery system 216). Additionally, system 300 includes additional features for implementing some of the components described in system 200. System 300 also includes the digital publishing application described above that is used to control and monitor a job processed by system 300 to generate communications in a variety of formats.

Referring now to FIG. 3, as described above, computer system 202 runs a variable information application for making templates which are used in generating the variable information communications. The templates include static fields, which are populated with information that remains the same for every communication produced from the template; and dynamic fields that are populated with information that is customized for an individual recipient, such as customer profile information (described in greater detail below). The dynamic fields reference varied data, which is inserted into the template when a job is processed to create output 214. The static fields and dynamic fields may be populated with text data and/or image data.

In some embodiments, the digital publishing application also includes a project management module. In system 300, the project management module is installed on computer system 202. In embodiments, the project management module includes a graphical user interface and is used to organize and manage templates created by a user using the variable information application. The project management module advantageously allows templates and related files, such as variable information files, to be organized into individual projects. The projects provide an efficient way of organizing and identifying a number of templates and variable information for use by system 300 to generate communications. By organizing templates into projects, a user only has to identify a project name when inputting job parameters for a job, and system 300 will recognize the specific templates that are associated with the project name. As one example, all files related to a promotional campaign or a specific client may be organized into a single project using the project management module. As will be apparent to those with ordinary skill in the art, the project management module may include additional features for managing templates and variable information.

As described above with respect to FIG. 2, computer system 202 runs the job management module of the digital publishing application. A user who wants to generate communications using system 300 will use the job management module to start, or otherwise prepare a job for processing by inputting job parameters. Examples of job parameters include, but are not necessarily limited to, job timing information indicating when a job is to be queued, job priority information indicating a priority for the job (e.g., low, medium, high), job type information indicating additional information about the job (e.g., the type of medium to be used to deliver the communications such as a batch of e-mails, printed material, or website communications), output type information (e.g., file format for the digital output), project information indicating the project under which the template files for the job are organized, and any additional setup information for processing a job. When a job is queued, the parameter information is sent to a storage location (i.e., a queue) located in database 204.

Database 204 is implemented in system 300 by project database 302 and job database 304. Project information database 302 is used to store project files organized and managed using the project management module run on computer 202. As described above, the project files may include template files and variable information used to populate the templates for creating the digital files of output 214.

Job database 304 stores a variety of information used by the digital publishing application, and more specifically the job management module, to manage a job. The queue for queuing a job is in database 304. In one embodiment, when a job is queued for processing, the job parameter information is stored in database 304 using a job table. Each job may have a separate table within database 304 for storing relevant job information, including the job parameters. Table 1 illustrates an exemplary table for storing job information in database 304.

TABLE 1
Exemplary Table for Storing Job Information
JOB

Job Queue
Job Priority
Job Type
Output Type
Project
Setup Information
Job Status
Job ID

As illustrated in Table 1, the job table includes fields for storing the job parameters input by a user using the job management module (job queue, job priority, job type, output type, project information and setup information). Additionally, the table also includes a job status field. The job status field stores job status information that indicates a status of the job. The job status information indicates whether a job has been queued, paused, cancelled, failed, currently processing, being post processed and/or successfully delivered to the recipients. The job status information is continually updated by different modules and applications as a job is processed. In addition to job status information, the job table includes a job ID number that is used to track a job through processing by system 300. The job ID number is persisted throughout the processing of a job to facilitate tracking of the job.

Either of databases 302 or 304 may store customer profile information. Customer profile information may include names and addresses of customers. In these embodiments, the names and addresses are variable information that is used to populate the dynamic fields of the templates to generate recipient specific communications. In some embodiments, customer profile information may relate to customers' preferences with respect to particular products or services. For example, if a job relates to generating communications advertising vehicles for sale, the customer profile information may relate to customers' preferences for vehicle color. In this case, the specific communication sent to a customer will reflect the customers' preference for a vehicle color. Customer profile information is used with, or is a part of, the project information used to create the customized communications for recipients.

In system 300, computer system 206 is implemented as server 306. Server 306 runs the job submission module of the digital publishing application, which manages and coordinates the job submission 208. When the job submission module determines that a job has been queued, it will retrieve the necessary information from databases 302 and 304. The job submission module will determine from the queued job parameters the information that it needs from databases 302 and 304 to create a job submission 208 for processing. For example, as stated above the parameters will indicate the project under which the template files for the job are stored in database 302. As another example, the job submission module also determines the format of the digital output 214 based on the queued job parameters, and when submitting job submission 208 for processing will include the file format information. The job submission module may also use the parameters to determine the order in which the job submission 208 is sent for processing. If there are multiple jobs in the queue, the job submission module will determine which of the jobs to submit first for processing based on priority information in the parameters.

The job submission module provides status information regarding job submission 208. In some embodiments, job submission module will store the information in the job table located in database 306. The status information indicates whether job submission 208 has been submitted for processing. Additionally, job submission module, in some embodiments, also communicates with and obtains status information from the variable information application on computer system 210. The status information from the variable information application indicates how the processing of job submission 208 is proceeding, i.e., currently processing, processed, etc. In these embodiments, the job submission module updates the job table stored in database 304 with the status information to allow a user to track the processing of job submission 208. For example, if during processing of a job there is an error, the job submission module may receive information about the error and update the job table in database 304 to reflect the error status of the job. A user can then access status information from the job table in database 304 using the job management module.

As described above, job submission 208 includes project files (e.g., templates, variable information) and parameter information (e.g., output format information). The job submission 208 is sent to the variable information application in computer system 210 for processing.

In system 300, computer system 210 is implemented as servers 308 that run variable information software to integrate the variable information into the templates submitted in job submission 208. In an embodiment, servers 308 include a number of servers that can each process a number of separate job submissions concurrently. Servers 308 populate the templates with the variable information referenced in the templates to generate digital output 214.

In addition to the variable information that is included in job submission 208, servers 308 may also retrieve digital assets (images, or other data) from a database such as database 212. Database 212 is implemented in an embodiment as database 310 and cache 312. The digital assets stored in database 310 and cache 312 are stored and retrieved using a digital asset management application, which may be run on server 311 or on system 210. In one embodiment, database 310 and cache 312 are used to store image data. The image data may be in different formats such as, EPS, TIFF, JPEG, or PDF. In some embodiments, a template will reference image data stored in database 310. When the template, as part of job submission 208, is processed by servers 308, the image data will be retrieved from cache 312, if stored therein; otherwise the image data will be retrieved from database 310, for including in digital output 214.

In embodiments, the digital publishing application provides for allowing a variable information application (such as Mpower Server) to interface with digital assets stored in a database managed by a digital asset management application (such as MediaBin). In one embodiment, database 310 is a structured query language (SQL) database. Images are stored and retrieved using the digital asset management application run on server 311. Templates with references to image data stored in database 310 are created on computer system 202. The references include meta-data that is associated with the image data stored in database 310. The variable information application stored and run on servers 308 hosts a plug-in that uses the meta-data to retrieve image data from database 310 during processing. When the servers 308 process the templates, the plug-in handles the requests for the image data. The plug-in uses the meta-data in the references to query database 310 through server 311 and retrieve the image data.

In some embodiments, the plug-in will retrieve image data that includes the actual image, which when retrieved is embedded within the digital output 214, as dictated by the templates. In other embodiments, the image data will be transferred into a cache, such as cache 314, and the location of the image data in the cache retrieved and embedded within the digital output 214. When the final communications are generated, e.g., print communications, the image will be included in the final communications, e.g., print communications.

In some embodiments, the plug-in used by the variable information software on servers 308 may access database 310 through a web service. For example, server 311 may be a web server that is accessed by servers 308 through the Internet. In this embodiment, database 310 may be located in a physically and substantially distant location from the servers 308. As described in the embodiment above, in some embodiments the plug-in may retrieve image data that includes the actual image, which when retrieved is embedded within the digital output 214. In other embodiments, the image data may be transferred into a cache, such as cache 314, and the location of the image data in the cache retrieved and embedded within the digital output 314. When the final communications are generated, the image will be included in the final communications.

In another embodiment, the digital publishing application may include a plug-in that is hosted within a variable information application used to create templates (such as Pageflex Studio). The plug-in creates an interface between the templates created with the variable information application and the digital assets in database 310 managed by a digital asset management application (such as MediaBin). When a user wants to use a digital asset from database 310 in a template, the plug-in will request meta-data for the digital asset from the digital asset management application on server 311 (note the connection between system 202 and server 311 is not shown). The plug-in will retrieve the associated meta-data and include the meta-data in a selected field within the template.

Referring now to cache 312, those with skill in the art will understand that cache 312 makes the process of retrieving digital asset information from database 310 more efficient. Cache 310 stores frequently requested digital asset information from database 310. Accordingly, when servers 308 request digital asset data for insertion into a template an attempt to service the request from cache 312 will be made. If cache 312 stores the digital asset information being requested, the request will be serviced from cache 312. If, however, the image data is not stored in cache 312, the image data will be retrieved from database 310, stored in cache 310 and forwarded to server 308 for including in the output 214. In some embodiment, cache 312 may include one or more levels of cache. Cache 312 may be implemented using any suitable computer storage media.

As previously described, digital output 214 includes a number of digital files each having the variable data tailored for a specific recipient. The specific format of the digital files that make up digital output 214 is determined by the job parameters input by a user. Servers 308 use the information from the job parameters to generate the digital files of digital output 214 in the desired format. Some examples of formats include VPS, PDF, HTML and JPEG. The format of the digital files will often depend on the medium by which the final communications will be sent to the intended recipients. For example, if the intended recipients will be viewing the communications on a web site, the digital files of digital output 214 may be in a PDF format. In this case, generating the communications from the digital files involves storing the digital files in a database for retrieving and displaying on a website. As another example, if the communications will be printed communications, digital output 214 may have the digital files in a VPS format. One feature of embodiments of the present invention is the ability to pre-select a format for the digital files based on a desired medium of communication to the intended recipients and be able to generate the communications on a single system 200 or 300. This feature of some embodiments eliminates the need for having separate systems in place for generating different types of communications.

Referring again to FIG. 3 and system 300, after servers 308 generate digital output 214 it proceeds to data delivery system 216. Data delivery system 216 is implemented with output delivery process 316, printing system 318, cache 314, web database 322, web server 320, and e-mail server 324. Data delivery system 216 processes digital output 214 to generate and deliver the final communications to the recipients.

Output delivery 316 delivers the appropriate digital files of digital output 214 to printing system 318, web database 320, web server 322 and e-mail server 324, and performs post processing on the digital files, if necessary, to ready the digital files for delivery. The post processing may include a number of steps. As one example, the digital files of digital output 214 may have filenames that are associated with the particular job, e.g. job ID numbers. However, the filenames are not associated with the intended recipients. Thus, during the post processing, the filenames may be renamed to correspond to the intended recipients of the communications.

Output delivery 316 may be implemented using any appropriate application and/or computer system. In one embodiment, servers 308 may store and run an application or module that performs the output delivery functions, including any post processing. In another embodiment, output delivery 316 may be performed using separate server(s) that store and run an application, or different modules of an application, for performing the output delivery 316.

Output delivery 316 routes the digital files of output 214 after any post processing to the necessary systems for delivery to the intended recipients. In some embodiments, the output may be stored temporarily in a staging process before it is passed to the systems for delivery to the recipients. For print communications, output delivery 316 sends the digital files to a printing system 318. The printing system 318 may include a number of printers located at the same location where the job is processed by servers 308. Alternatively, the printing system 318 may occur at some off-site print vendor location, in which case the necessary digital files are delivered over a network to the print vendor for generating the print communications. Cache 314 stores digital assets, as described above, that are included in the final print communications generated from the digital files. After printing system 318, generates the print communications 330, they are delivered to the intended recipients, and status information 218 is sent to the job management module on computer system 202, which in one embodiment stores the information in database 304, indicating that the print communications 330 have been delivered to the intended recipients.

Those digital files of the output 214 that will be sent to the intended recipients via electronic mail are sent by output delivery 316 to e-mail server 324, which sends the e-mail communications 332 to the intended recipients. After sending the e-mail communications 332, e-mail server 324 sends status information 218 to the job management module on computer system 202.

The digital files of output 214 that are used for web site communications 334 are routed to web database 320, where web server 324 accesses them and displays them on web sites for viewing by the intended recipients. Web server 324 will also send status information 218 to the job management application indicating that the web site communications 334 have been delivered.

It should be understood that data delivery system 216 is not limited to the parts discussed above. In other embodiments, the final communications will be delivered to their intended recipients using other mediums of communication, some examples including television such as delivering the communications through a cable television network, storing the communications as advertising on CD-ROMs sent to the intended recipients. In these embodiments, data delivery system 216 will include additional systems and process for delivering the communications to the intended recipients via the other mediums of communications.

It will be understood by those of skill in the art that in alternative embodiments, the variable digital publishing systems (200 and 300) and the digital publishing application described above, may include components, computer systems, applications, modules, processes, functions, and methods in addition to those described above. Indeed, one feature of embodiments of the present invention is that the digital publishing application may be used to manage and control a system that is capable of generating as many communications as is required, i.e., a small system for small numbers of communications and a large system for large numbers of communications. For example, additional computer systems and/or servers may be added to computer systems 202, 206 and 210 to increase the number of communications processed by systems 200 and 300.

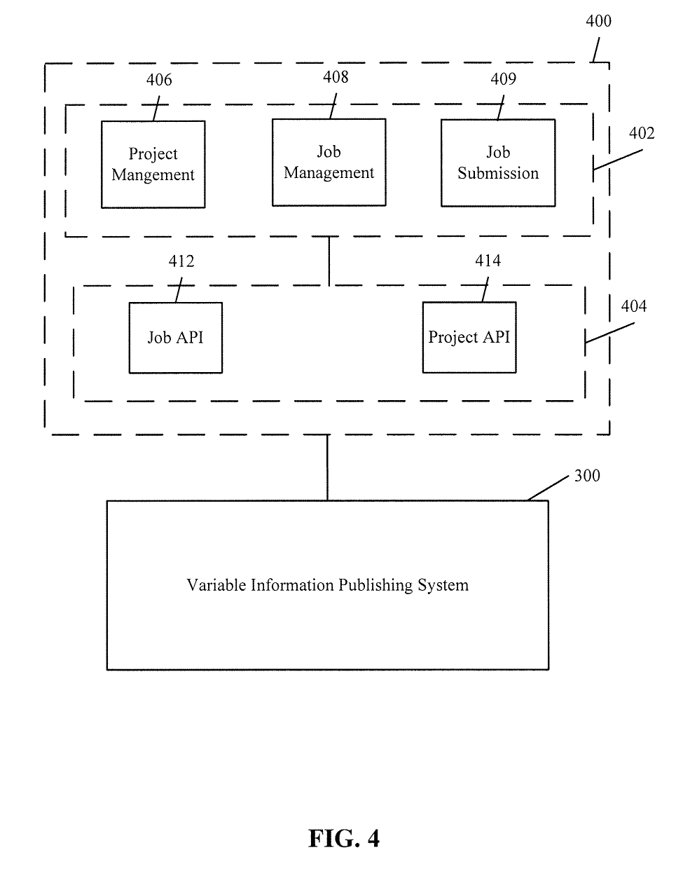

FIG. 4 illustrates a block diagram of a software application for controlling and accessing resources in a variable digital publishing system according to one embodiment of the present invention. FIG. 4 shows a digital publishing application 400 that is used to control and interact with a variable digital publishing system, such as system 300 described above with respect to FIG. 3. As described above with respect to FIG. 3, system 300 may include a number of resources such as computer systems, networks, communication links, applications (e.g., digital asset management applications, variable information software applications) and I/O devices used in processing a batch of recipient specific communications. Application 400 includes modules 402, which provide for controlling and accessing resources within system 300. Application 400 also includes application-programming interfaces (APIs) 404, which are called by the modules to allow the modules to control and access resources within system 300. Modules 402 include project management module 406, job management module 408, and job submission module 409. APIs 404 include job API 412 and project API 414.

Project management module 406 allows a user to generate and manage variable information projects. The projects may include a variety of files such as templates for use in generating variable information communications and dynamic data referenced within the templates. Project management module 406 may be stored and run on a computer system such as computer system 202 described above with respect to FIGS. 2 and 3. Project management module 406 may access resources within system 300, such as databases to store and retrieve project files. Additionally, project management module 406 may interface with other applications in system 300. For example, if system 300 includes a digital asset management application that is used to store and manage digital assets, project management module 406 may interface with the digital asset application to include digital assets as part of some of the project files.

Project API 414 is operable to communicate with a number of resources in system 300. Project API 414 is used by project management module 406 to access resources in system 300. For example, project API 414 may be called by project management module 406 to store project files in databases within system 300. Additionally, project API 414 may be called to interface with digital asset management applications for accessing digital assets. These are some exemplary functions that project API 414 may perform. Those with skill in the art will appreciate that project API 414 may be designed to interface with other resources within system 400.

Job management module 408 is used to control and manage the processing of a job by system 300. Module 408 is used to perform a variety of functions for managing and processing of a job. For example, module 408 is used to receive job parameters input by a user for queuing and submitting a job for processing. Additionally, job management module 408 may also be used to monitor the progress of a job. Module 408 may be used to determine the status of a particular job, such as by accessing job tables stored in a database in system 300. As an additional example, if a user wants to know what jobs are in queue to be processed by system 300, job management module 408 is used to determine which jobs are in the queue and their schedule for processing.

In some embodiments, module 408 is also used to generate reports regarding the processing of a job or a number of jobs. For example, if a series of jobs is performed over a period of time, e.g. a month, job management module 408 may be used to generate a report for each of the jobs. The reports may include information regarding processing results, any errors that may have occurred during the processing of the jobs, project information for the jobs and results of delivering the communications to the recipients.

Job submission module 409 is used to generate a job submission for processing by system 300. The job submission module 409 examines job parameters that have been queued, and generates a job submission by retrieving project files and variable information necessary for processing a job. After a job submission has been generated, the job submission module 409 sends the job submission to a variable information application for processing.

Job API 412 is operable to communicate with a number of resources in system 300. Job API 412 is called by job management module 408 and job submission module 409 to communicate with resources of system 300 and perform functions in system 300. For example, when a report is being generated using job management module 408, job API 412 may be called on to retrieve information from a job table stored in a database in system 300 to access parameter information, status information and project information for including in the report. As another example, if job management module 408 is used to receive job parameters, job API 412 may be called to store the parameters in a job table. In some embodiments, job API 412 may be called by job submission module 409 to retrieve project files from a database, or to store status information in a database. Those with skill in the art will appreciate that job API 412 is not limited to the functions described above, and may be designed to interface with other resources within system 400.

In other embodiments of the present invention, application 400 may include other modules 402 and other APIs 404 in addition to those described above. Moreover, it should be understood that the various modules may be stored and run on a single computing system; be stored and run on separate computing systems such as in a distributed computing environment; or combinations of the modules may be stored and run on separate computing systems. Also, the modules may themselves include a number of instructions, methods and components that may be distributed on separate computer systems in a distributed computing environment.

Similarly, the various APIs may be stored and run on a single computing system; be stored and run on separate computing systems such as in a distributed computing environment; or combinations of the API's may be stored and run on separate computing systems. The APIs may themselves include a number of instructions, methods and components that may be distributed on separate computer systems in a distributed computing environment.

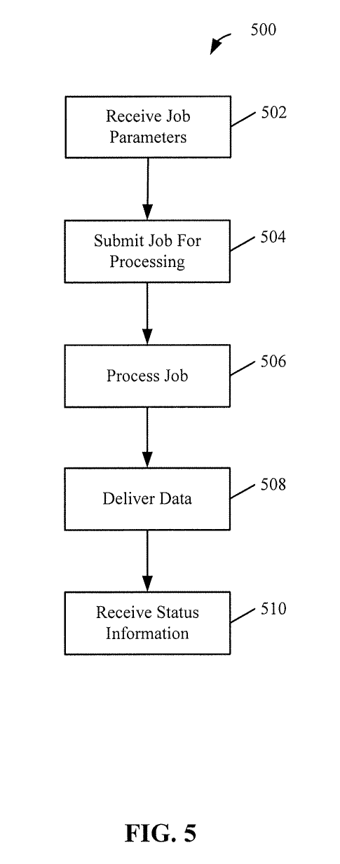

FIG. 5 illustrates a process 500, according to one embodiment of the present invention, for generating a recipient specific communication incorporating variable information. First, receive job parameters 502 receives information regarding particular parameters of a job, which is processed to generate a digital output file used to create the communication. In some embodiments, the parameters may include without limitation job timing information indicating when a job is to be queued for processing by a variable information application, job priority information indicating a priority for the job (e.g., low, medium, high), job type information indicating information about the job (e.g., a batch of e-mails, printed material, or website communications), output type information (e.g., file format for the digital output), and project information indicating the project under which template files for the job are organized. The parameter information is used for creating a job that is then submitted to a variable information application for processing.

Submit job 504 submits the job to a variable information application for processing to generate an output file. The job submitted by submit job 504, includes, in some embodiments, at least some of the parameter information received at 502 and also a template that references variable information that is populated in the template during processing. In embodiments, submit job 504 may be preceded by steps for gathering the necessary information for creating the job prior to performing submit job 504. For example, submit job 504 may be preceded by steps for retrieving a template and parameter information received at 502.

After submit job 504, process job 506 processes the job to generate the digital output file. As previously described, process job 506 may be performed by a variable information application that populates the template with variable information to generate the digital output file. The variable information used to populate the template may be text or graphic information, and is specifically tailored for an intended recipient of the communication generated from the digital output file.

Deliver data 508 generates the final communication using the digital output file and delivers the communication to the intended recipient. Deliver data 508 may include steps for post processing of the digital output file, which may include renaming the digital file, printing the digital file, or changing the file format of the digital file. Deliver data 508 then routes the communication to the intended recipient via a medium of communication.

Receive status information 510, receives status information regarding deliver data 508. In embodiments, the status information relates to whether the communication was successfully delivered to the intended recipient. Receive status information 510 provides for monitoring the delivery of the communication to the recipient. Although receive status information 510 is illustrated in flow chart 500 as following deliver data 508, in other embodiments, receive status information 508 may occur during or after each of operations receive job parameters 502, submit job 504, process job 506, and/or deliver data 508. In these embodiments, receive status information 510 allows the entire process 500 to be tracked and monitored to determine the status of generating the communication.

The process illustrated by flow chart 500 may be implemented by one or more software applications. In one embodiment, the process is implemented using at least some of the modules of digital publishing application described above with respect to FIGS. 2 and 3, which are stored and run on a number of computer systems and/or servers. In other embodiments, it may be implemented using application 400 described above with respect to FIG. 4. Process 500, however, is not limited thereto, and may be implemented using other software applications.

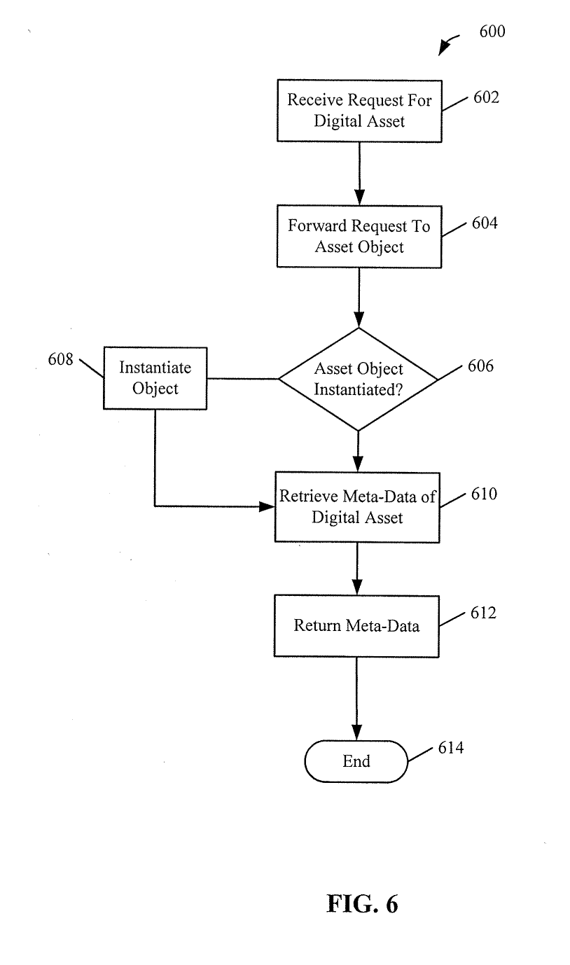

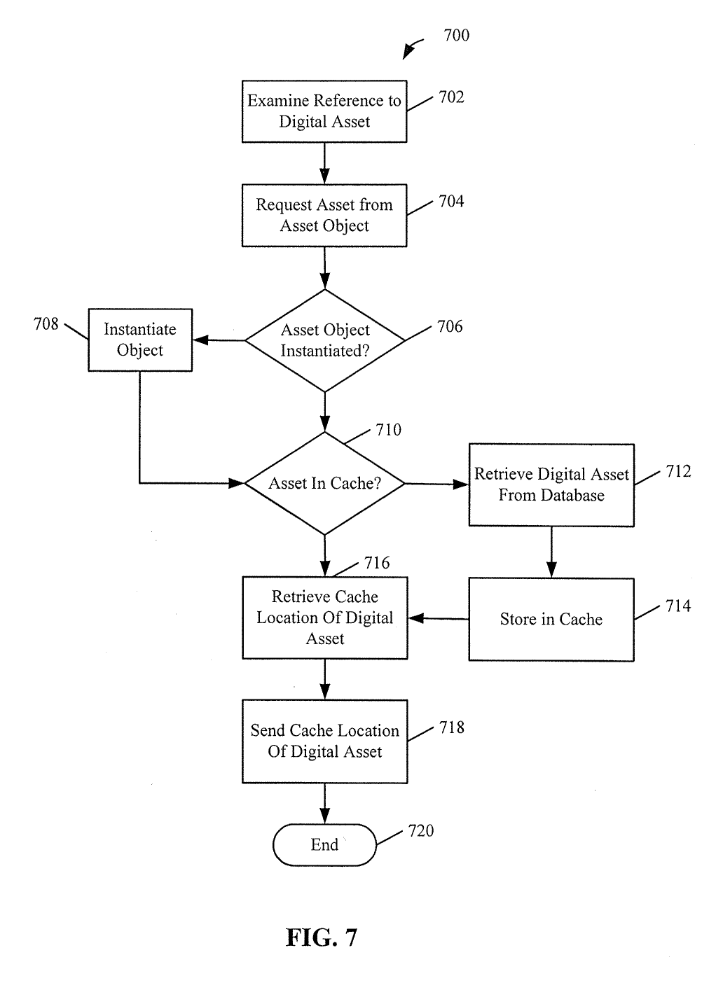

In some embodiments, the present invention relates to processes and methods of facilitating the interface between variable information software applications and digital asset management software applications. Embodiments according to the present invention are illustrated in FIGS. 6 and 7.

FIG. 6 illustrates a process 600 of retrieving meta-data associated with a digital asset managed by a digital asset management application, for including in a template created with a variable information application. The method begins at receive request for digital asset 602. The request may be generated as a result of a user requesting a digital asset to include in a template. The digital asset may relate to, for example, images stored and managed by the digital asset management application.

Forward request to asset object 604, forwards the request for the digital asset to an asset object. The asset object is a software object that is programmed to interface with the digital asset management application to retrieve meta-data associated with the requested digital asset. At decision 606, a determination is made whether the asset object has been previously instantiated. If the asset object has not been previously instantiated, the asset object is instantiated by instantiate object 608. Operation then passes to retrieve meta-data of digital asset 610. If the asset object has been previously instantiated, operation will pass directly to retrieve meta-data 610. Retrieve meta-data 610 is performed by the asset object, which interfaces with the digital asset management application using for example an API of the digital asset management application.

After the meta-data is retrieved, return meta-data 612 returns the meta-data. Return meta-data is performed by the asset object, which will return the meta-data to the variable information application. The meta-data may then be used by the variable information application in templates. After the return meta-data 610, the method ends 614.

Process 600 may be implemented using any suitable software application. In one embodiment of the present invention, the method is implemented as a plug-in hosted within a variable information application. The plug-in provides a list of digital assets that a user of the variable information application may include in a template. When a user selects a digital asset that is stored in a digital asset management application, process 600 is performed by the plug-in to retrieve the meta-data of the asset. This is only one embodiment, and as those with skill in the art will appreciate, process 600 may be implemented in other ways.

FIG. 7 illustrates a process 700 for retrieving a cache location of a digital asset managed by a digital asset management application. The process may be used for example by a variable information application that processes templates by populating the templates with variable information to generate digital output used in creating communications. As previously described, in some cases the digital output will include embedded cache locations of digital assets, such as images. When the digital files of the digital output are processed to generate the communications, the digital assets will be included in the final communications. Thus, FIG. 7 illustrates a process that is useful in this situation. However, it should be understood that in other instances where the actual digital assets are embedded within the digital output, the method illustrated in FIG. 7 may be used to retrieve the actual digital assets for embedding within the digital output.

The method begins at examine reference 702. Examine reference 702 is performed by a variable information application processing a template that includes a reference to a digital asset. The reference may include for example meta-data that is associated with the digital asset. In some embodiments, examine reference 702 may involve parsing the reference to extract the meta-data associated with the digital asset.

After examine reference 702, a request for the digital asset is made by request asset 704. The request for the digital asset is made to an asset object. The asset object is a software object that is programmed to retrieve the cache location of the requested digital asset that is stored in cache managed by a digital asset management application.

At decision 706, a determination is made whether the asset object has previously been instantiated. If the asset object has not previously been instantiated, operation passes to instantiate object 708, which instantiates the object for handling the request. Operation then passes to decision 710. If however, the asset object is already instantiated operation passes directly to decision 710.

At decision 710, a determination is made regarding whether the digital asset is stored in cache. If the digital asset is not stored in cache, retrieve digital asset 712 retrieves the digital asset from a database that stores the digital asset. Store in cache 714 stores the digital asset in the cache. Operation then passes to retrieve cache location 716. If at decision 710 it is determined that the digital asset is already stored in the cache, operation passes directly to retrieve cache location 716.

Retrieve cache location 716 retrieves the location in the cache where the digital asset is stored. Retrieve cache location 716 is performed by the asset object. After retrieve cache location 716, send cache location 718 sends the cache location of the digital object to the variable information application for including in the digital output. After send cache location 718, the process ends at 720.

The process 700 may be implemented using any suitable software application. In one embodiment of the present invention, the method is implemented as a plug-in hosted within a variable information application, which integrates variable information into templates to generate output files used in generating communications. When a template is processed by the variable information application and includes a digital asset that is stored in a digital asset management application, process 700 is performed by the plug-in to retrieve the cache location of the digital asset to include in the digital files of the digital output. This is only one embodiment, and process 700 may be implemented in other ways.

The various embodiments described above are provided by way of illustration only and should not be construed to limit the invention. Those skilled in the art will readily recognize various modifications and changes that may be made to the present invention without following the example embodiments and applications illustrated and described herein, and without departing from the true spirit and scope of the present invention.

What is claimed is:

1. A computer implemented method of generating a communication for delivery to a recipient, wherein the communication comprises variable information, the method comprising:
receiving job parameter information for generating an output file, wherein the job parameter information comprises file format information indicating a file format for the output file;
submitting a job to a variable information application for processing to generate the output file in the file format, wherein the job comprises a template and the file format information, and wherein the variable information application generates the output file by populating the template with the variable information;
delivering the output file to a data delivery system for generating the communication and sending the communication to the recipient; and
receiving delivery status information indicating whether the communication has been sent to the recipient.

2. The method of claim 1, further comprising receiving job status information indicating whether the job has been submitted to the variable information application.

3. The method of claim 1, further comprising receiving job status information indicating whether the job is processing.

4. The method of claim 1, further comprising receiving job status information indicating whether the job has been processed.

5. The method of claim 1, further comprising after the receiving, storing the job parameter information in a job table.

6. The method of claim 5, further comprising storing the delivery status information is in the job table.

7. The method of claim 1, wherein the job parameter information further comprises information indicating a storage location of the template for retrieving the template prior to the submitting.

8. The method of claim 1, wherein the job parameter information further comprises priority information indicating a priority of the job.

9. The method of claim 1, wherein the communication is an e-mail communication and the generating and sending comprise sending the output file as an e-mail to the recipient.

10. The method of claim 1, wherein the communication is a print communication and the generating comprises printing the output file.

11. The method of claim 1, wherein the communication is a web communication and the generating comprises storing the communication in a web database for later displaying on a web site.

12. A variable data publishing system for generating a communication with variable information for delivery to a recipient, the system comprising:
a server that stores and runs computer executable instructions for:
receiving parameter information for generating an output file, wherein the parameter information comprises file format information representing a file format for the output file and information representing a template to be used in generating the output file;
submitting a job for processing to a variable information application, wherein the job includes the file format information, the template and variable information; and
sending job status information regarding the submitting of the job;
a data delivery system, for generating the communication from the output file, sending the communication to the recipient and sending delivery status information indicating whether the communication has been sent to the recipient.

13. The system of claim 12, further comprising a second server for storing and running the variable information application.

14. The system of claim 12, further comprising a database for storing the job parameters, the job status information, and the delivery status information.

15. The system of claim 12, wherein the communication is a print communication and the data delivery system comprises a printer for printing the output file to generate the print communication.

16. The system of claim 12, wherein the communication is an e-mail communication and the data delivery system comprises an e-mail server for e-mailing the output file to generate the e-mail communication.

17. The system of claim 12, wherein the communication is a web communication and the data delivery system comprises a web server for displaying the output file to generate the web communication.

18. A computer implemented method comprising:
receiving a request from a variable information application for a digital asset stored in a database managed by a digital asset management application;
forwarding the request to a digital asset object, wherein the digital asset object retrieves information associated with the digital asset from the digital asset management application; and
receiving the information from the digital asset object.

19. The computer readable media of claim 18, wherein the information associated with the digital asset comprises meta-data identifying the digital asset.

20. The computer readable media of claim 18, wherein the information associated with the digital asset comprises a memory location where the digital asset is stored.

21. The computer readable media of claim 20, wherein the digital asset is stored in cache and the memory location is a cache memory location.

22. The computer readable media of claim 18, wherein the information associated with the digital asset comprises the actual digital asset.

23. A computer-readable media having stored thereon computer executable instructions that when executed perform the steps of:
receiving a request from a variable information application for a digital asset stored in a database managed by a digital asset management application;
forwarding the request to a digital asset object, wherein the digital asset object retrieves information associated with the digital asset from the digital asset management application; and
receiving the information from the digital asset object.

24. The computer readable media of claim 23, further comprising incorporating the information into a template generated using the variable information application.

25. The computer readable media of claim 23, further comprising populating a template with the information to generate a digital output file embedded with the information.

26. The computer readable media of claim 25, wherein the digital asset comprises an image.

27. The computer readable media of claim 26, wherein the information associated with the image comprises a memory location where the image is stored.

28. The computer readable media of claim 27, wherein the image is stored in cache and the memory location is a cache memory location.
